(19) United States
(12) Patent Application Publication
(10) Pub. No.: US 2026/0145534 A1
(43) Pub. Date: May 28, 2026

(54) VEHICLE THERMAL SYSTEM WITH EMERGENCY LIFESAVING OPERATION

(71) Applicant: FCA US LLC, Auburn Hills, MI (US)

(72) Inventors: Mark J Skynar, Auburn Hills, MI (US); Shanka Natarajan, Windsor (CA); Oliver Gross, Auburn Hills, MI (US); Sadek Rahman, Auburn Hills, MI (US); Mark M Doroudian, Auburn Hills, MI (US)

(21) Appl. No.: 18/961,739

(22) Filed: Nov. 27, 2024

(51) Int. Cl. B60L 3/00; B60H 1/00; B60L 50/60; B60L 58/12; H01M 10/42

(52) U.S. Cl. CPC B60L 3/0046; B60H 1/00735; B60H 1/00978; B60L 50/60; B60L 58/12; H01M 10/425; H01M 2010/4271; H01M 2220/20

(57) ABSTRACT

A thermal system for an electrified vehicle with an electric motor powered by a high voltage (HV) battery system includes a heating, ventilation, and air conditioning (HVAC) system configured to control an environment of a passenger cabin. A controller is configured to monitor a state of charge (SOC) of the HV battery system to determine if the SOC is less than or equal to a predetermined minimum SOC, monitor sensors to detect one or more predetermined temperature conditions dangerous to human life, and initiate an emergency lifesaving mode when (i) the SOC is less than or equal to the predetermined minimum SOC, and (ii) the predetermined temperature conditions dangerous to human life are detected. In the emergency lifesaving mode, the HVAC system compressor and blower are activated and powered by the HV battery system to maintain the cabin environment at a temperature to prevent life threatening temperature conditions.

### FIELD

The present application relates generally to vehicle thermal systems and, more particularly, to a vehicle thermal system with an emergency lifesaving operation for electrified vehicles.

### BACKGROUND

Modern passenger vehicles typically include a heating, ventilation, and air conditioning (HVAC) system to control the environment in the vehicle cabin to improve passenger comfort. However, in extreme ambient temperatures, the HVAC system may incapable of providing the desired passenger comfort level. Furthermore, in some critical scenarios, the extreme ambient temperatures may be dangerous to human life. For example, some regions on Earth have temperature and humidity levels where human beings are unable to survive inside or even outside of the vehicle for an extended period of time. Thus, while such conventional systems generally work well for their intended purpose, there is a desire to provide improvement in the relevant art.

### SUMMARY

According to one example aspect of the invention, a thermal system for an electrified vehicle having an electrified powertrain with an electric motor powered by a high voltage (HV) battery system is provided. In one exemplary implementation, the thermal system includes a heating, ventilation, and air conditioning (HVAC) system configured to control an environment of a cabin of the electrified vehicle, the HVAC system including a compressor, a condenser, an evaporator, and a blower, one or more sensors, and a controller.

The controller includes one or more processors and a non-transitory computer-readable storage medium having a plurality of instructions stored thereon, which, when executed by the one or more processors, cause the one or more processors to perform operations comprising: monitor a state of charge (SOC) of the HV battery system to determine if the SOC is less than or equal to a predetermined minimum SOC, monitor the one or more sensors to detect one or more predetermined temperature conditions dangerous to human life, and initiate an emergency lifesaving mode when (i) the SOC is less than or equal to the predetermined minimum SOC, and (ii) the predetermined temperature conditions dangerous to human life are detected. In the emergency lifesaving mode, the HVAC system compressor and blower are activated and powered by the HV battery system to maintain the cabin environment at a temperature to prevent life threatening temperature conditions.

In addition to the foregoing, the described thermal system may include one or more of the following features: wherein in the lifesaving mode, the HV battery system is allowed to be reduced to an absolute zero SOC to preserve human life; wherein in the lifesaving mode, all non-essential vehicle systems that utilize HV battery system power are shut down; wherein in the lifesaving mode, the electrified vehicle is prevented from driving; wherein the predetermined minimum SOC is a SOC where the HV battery system is shut down and prevents further driving to extend a life and durability of the HV battery system; and wherein when (i) the SOC is less than or equal to the predetermined minimum SOC, and (ii) the predetermined temperature conditions dangerous to human life are detected, the controller is further configured to display a notification on a vehicle screen asking if a user would like to initiate the emergency lifesaving mode.

In addition to the foregoing, the described thermal system may include one or more of the following features: wherein the controller is further configured to detect if a user does not select to initiate the emergency lifesaving mode, determine if a passenger is detected within the vehicle cabin, if the user does not select to initiate the emergency lifesaving mode, and automatically initiate the emergency lifesaving mode if a passenger is detected within the vehicle cabin; wherein the predetermined temperature conditions are an exterior wet bulb temperature; wherein the predetermined temperature conditions are greater than or equal to an exterior wet bulb temperature of 31° C.; and wherein the predetermined temperature conditions are a temperature of the vehicle cabin.

According to another example aspect of the invention, a method of operating a thermal system of an electrified vehicle having a passenger cabin, a high voltage (HV) battery system to power an electric motor, a heating ventilation and air conditioning (HVAC) system having a compressor and a blower, and one or more sensors is provided. In one implementation, the method includes: monitoring, by a controller having one or more processors, a state of charge (SOC) of the HV battery system to determine if the SOC is less than or equal to a predetermined minimum SOC; monitoring, by the controller, the one or more sensors to detect one or more predetermined temperature conditions dangerous to human life; and initiating, by the controller, an emergency lifesaving mode when (i) the SOC is less than or equal to the predetermined minimum SOC, and (ii) the predetermined temperature conditions dangerous to human life are detected. In the emergency lifesaving mode, the HVAC system compressor and blower are activated and powered by the HV battery system to maintain an environment of the passenger cabin at a temperature to prevent life threatening temperature conditions.

In addition to the foregoing, the described method may include one or more of the following features: wherein in the lifesaving mode, the HV battery system is allowed to be reduced to an absolute zero SOC to preserve human life; shutting down, by the controller, all non-essential vehicle systems that utilize HV battery system power when in the lifesaving mode; preventing, by the controller, driving of the electrified vehicle when in the lifesaving mode; wherein the predetermined minimum SOC is a SOC where the HV battery system is shut down and prevents further driving to extend a life and durability of the HV battery system; and wherein when (i) the SOC is less than or equal to the predetermined minimum SOC, and (ii) the predetermined temperature conditions dangerous to human life are detected, the method further includes displaying, by the controller, a notification on a vehicle screen asking if a user would like to initiate the emergency lifesaving mode.

In addition to the foregoing, the described method may include one or more of the following features: detecting, by the controller, if a user does not select to initiate the emergency lifesaving mode; determining, by the controller and the one or more sensors, if a passenger is detected within the vehicle cabin, if the user does not select to initiate the emergency lifesaving mode; and automatically initiating, by the controller, the emergency lifesaving mode if a passenger is detected within the vehicle cabin; wherein the predetermined temperature conditions are an exterior wet bulb temperature; wherein the predetermined temperature conditions are greater than or equal to an exterior wet bulb temperature of 31° C.; and wherein the predetermined temperature conditions are a temperature of the vehicle cabin.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example electrified vehicle having an emergency lifesaving HVAC system in accordance with the principles of the present disclosure;

FIG. 2 is a schematic diagram of an example thermal system of the electrified vehicle of FIG. 1, in accordance with the principles of the present disclosure; and

FIG. 3 is a flow diagram of an example emergency lifesaving HVAC control method, in accordance with the principles of the present disclosure.

### DETAILED DESCRIPTION

As previously discussed, passenger vehicles typically include a heating, ventilation, and air conditioning (HVAC) system to control the environment in the vehicle cabin to improve passenger comfort. However, in extreme ambient temperatures, the HVAC system may incapable of providing the desired passenger comfort level. Furthermore, in some critical scenarios, the extreme ambient temperatures may be dangerous to human life.

Accordingly, systems and methods are provided herein for an emergency lifesaving HVAC system for an electrified vehicle such as, for example, a hybrid electric vehicle (HEV) or a battery electric vehicle (BEV). The system includes a high voltage (HV) battery system along with an electric HV HVAC compressor and controlling software. The system is configured to attempt to save human life during extreme ambient conditions (hot and cold) when the vehicle has used all the available fuel or normally available displayed battery electric energy state of charge (SOC).

In one example, the electrified vehicle includes an electrified powertrain having one or more electric traction motors powered by a HV battery system. The HV battery system is also configured to provide electrical energy to other components of the electrified vehicle, such as the HVAC system. In newer electrified vehicles, the HV battery system is designed to shut down all HVAC systems when the HV battery reaches approximately 0% SOC on the vehicle display. However, in this situation, the actual HV battery SOC is closer to approximately 20% SOC to prolong the life and durability of the HV battery over thousands of cycles. Accordingly, in the normal course of operation, the vehicle is designed to shut down power systems (e.g., HVAC) when the SOC reaches a predetermined minimum threshold (e.g., 20%).

However, when life threatening temperature conditions occur, the electrified vehicle control system is configured to manually or automatically go into an emergency lifesaving HVAC operation to preserve human life when the HV battery SOC reaches the predetermined minimum threshold, instead of shutting down. In one example, the vehicle monitors various conditions and enables the vehicle to enter the emergency lifesaving HVAC mode when the conditions are met. Example conditions include vehicle cabin temperature/humidity (e.g., wet bulb temperature, apparent temperature, wet bulb globe temperature), exterior/ambient temperature/humidity (e.g., wet bulb temperature, apparent temperature, wet bulb globe temperature), outdoor solar load, passenger presence within the vehicle cabin, and/or HV battery system SOC. When the predetermined conditions are met, the vehicle control system is configured to operate the HV electric HVAC compressor and a low voltage (LV) HVAC blower to maintain the vehicle cabin temperature or wet bulb temperature at a predetermined maximum or minimum.

One goal is to preserve human life with the least amount of energy for about 4-8 hours. Peak temperatures are typically in the afternoon and by about four hours later, the temperature drops to a livable temperature. In one example, parameters to keep the person(s) alive are to reduce the humidity in the passenger cabin and maintain the cabin at a predetermined livable temperature. In some scenarios, while reducing cabin humidity, the vehicle is configured to cool the humid cabin air to remove water therefrom. The condensed water may then be collected in a reservoir and provided to the cabin passengers as drinkable water.

In one example, the emergency HVAC system is initiated when the outside solar load exceeds a predetermined threshold solar load, the outside wet bulb temperature exceeds a predetermined threshold wet bulb temperature, the outside apparent temperature (temperature/humidity) exceeds a predetermined threshold apparent temperature, and/or the wet bulb globe temperature (WBGT) exceeds a predetermined threshold WBGT. In one example, the threshold solar load is 1,000 watts per square meter or approximately 1,000 watts per square meter. In another example, the threshold wet bulb temperature is 31.0° C. or approximately 31.0° C. In another example, the threshold apparent temperature is 130° F. or approximately 130° F. In yet another example, the threshold WBGT is 90° F. or approximately 90° F.

Once the emergency HVAC system is activated, the vehicle can use the remaining HV battery power and operate until absolute zero power/charge to prioritize the preservation of human life over battery life. The HV battery system software is configured to utilize the least amount of energy necessary to run the HV electric HVAC compressor and LV HVAC blower to maintain the cabin temperature at a predetermined maximum wet bulb temperature (e.g., 31.0° C.) to prevent the passengers inside the vehicle from exceeding a predetermined internal temperature (e.g., 39.0° C.) that may be dangerous to life.

In some scenarios, the emergency HVAC system has a run time of between approximately four and eight hours, and is configured to operate until sunset or when the internal/external environment is no longer life threatening. The system may also be similarly operated in extremely cold temperatures by maintaining a minimum passenger cabin temperature (or wet bulb temperature). Additionally, the emergency HVAC system may be linked to infant detection systems, emergency SOS/alarm systems, and/or an emergency cellular service or number (e.g., 9-1-1).

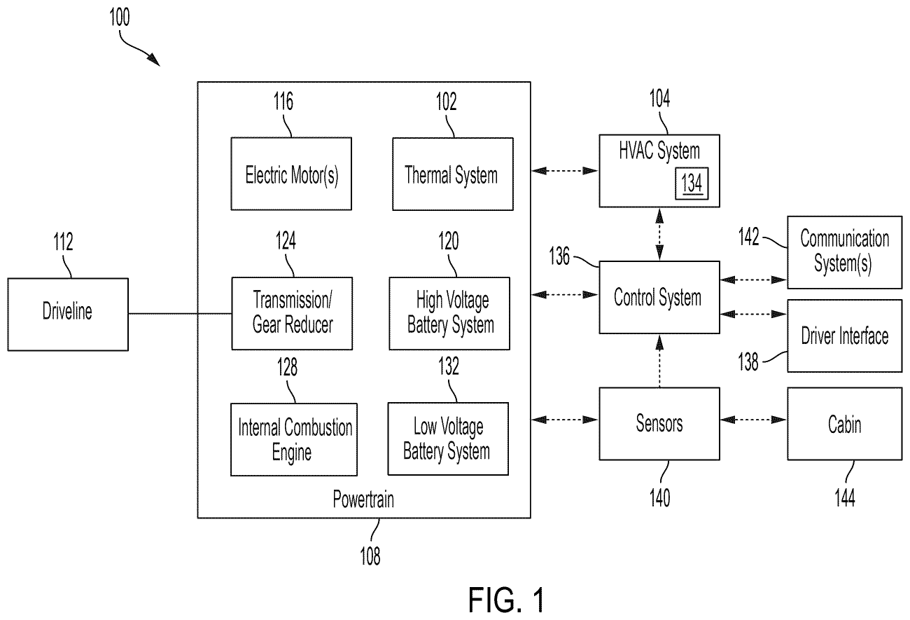

With initial reference to FIG. 1, a functional block diagram of an electrified vehicle 100 having a thermal system 102 with an example HVAC system 104 configured to perform an emergency lifesaving operation according to the principles of the present application is illustrated. The electrified vehicle 100 could be any suitable type of electrified vehicle, including, but not limited to, a HEV. The electrified vehicle 100 comprises an electrified powertrain 108 configured to generate and transfer drive torque to a driveline 112 for vehicle propulsion. The electrified powertrain 108 includes one or more electric traction motors 116 each configured to generate mechanical drive torque using energy (e.g., electrical current) supplied by a high voltage (HV) battery system 120. For example, an inverter (not shown) could be used to convert the direct current (DC) from the high voltage battery system 120 to three-phase alternating current (AC) to power the electric traction motor(s) 116. A transmission 124 (e.g., an automatic transmission) is configured to transfer the drive torque from the electrified powertrain 108 to the driveline 112.

The electrified powertrain 108 may also include an internal combustion engine 128 configured to combust a mixture of air and fuel (gasoline, diesel, etc.) to generate mechanical torque for vehicle propulsion and/or conversion to electrical energy, such as for recharging battery system 120. A low voltage battery system 132 (e.g., a 12-volt (V) battery) is configured to power low voltage components and accessory loads of the electrified vehicle 100, such as an HVAC blower 134.

A control system 136 is configured to control the electrified powertrain 108, including controlling the electrified powertrain to generate an amount of drive torque to satisfy a torque request provided by a driver/operator via a driver interface 138 (e.g., an accelerator pedal). A plurality of sensors 140 are configured to measure operating parameters of the electrified vehicle 100, such as, but not limited to, speeds/accelerations, pressures, temperatures, and electrical parameters (voltage, current, state of charge, etc.). The sensors 140 also include other vehicle systems, such as a GPS navigation/maps system. In one particular example, the sensors 140 are configured to measure external solar load, exterior temperature, exterior wet bulb temperature, exterior WBGT, passenger cabin temperature, passenger cabin wet bulb temperature, and/or a passenger presence within the vehicle. In this way, at least some of the sensors 140 are associated with a vehicle cabin 144.

The control system 136 is also configured to communicate with other devices/systems using one or more communication systems 142 each configured for communication via a particular communication network or medium. For example, the communication systems 142 could include a long-range cellular communication transceiver, and/or a short-range wireless communication (e.g., Bluetooth) transceiver. One particular communication by the control system 136 via the communication system 142 is with emergency services (e.g., 9-1-1).

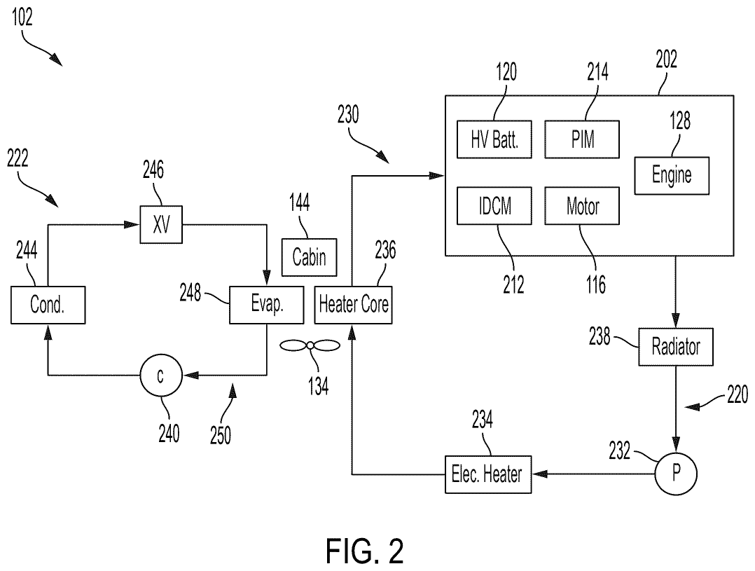

With reference now to FIG. 2, the thermal system 102 of the electrified vehicle that includes the HVAC system 104 is illustrated according to the principles of the present application. The thermal system 102 is configured to provide heating/cooling to various components 202 of the vehicle such as power electronics including an integrated dual charging module (IDCM) 212, a power inverter module (PIM) 214, electric motors 116, high voltage (HV) battery system 120, and engine 128 (if present). The IDCM 212 includes a DC/DC converter that converts high voltage from the battery system 120 to power lower voltage electrical loads and charge a low voltage battery, and an on-board charging module that converts AC power from the wall to DC to charge the HV battery system 120 when the vehicle is plugged in.

In the example embodiment, the thermal system 102 generally includes a high temperature coolant loop 220 and an A/C coolant loop 222. In the illustrated example, the high temperature loop 220 circulates a heat transfer fluid or coolant (e.g., water) and generally includes a main circuit 230 having a pump 232, a HV electric heater 234, a heater core 236, and a high temperature radiator 238. It will be appreciated that high temperature coolant loop 220 may be comprised of two or more fluidly connected or fluidly separate coolant loops (e.g., one for the battery system, one for the engine).

The pump 232 is configured to circulate the coolant around the main circuit 230, and the heater 234 is configured to selectively heat the coolant passing through the main circuit 230 when additional heating is desired. The heater core 236, which is a passenger cabin heat exchanger operably associated with blower 134, is configured to receive heated coolant to thereby provide heating to air supplied to the passenger cabin 144 by blower 134.

in the example implementation, A/C coolant loop 222 is part of the HVAC system 104 and generally includes a HV electric compressor 240, a condenser 244, an expansion device 246, and an evaporator 248. It will be appreciated that A/C coolant loop 222 may have additional branches, as well as additional components, such as a chiller and an accumulator. In operation, a suction line 250 provides gaseous refrigerant to compressor 240, which subsequently compresses the refrigerant. The compressed and heated refrigerant is then directed to the condenser 244 where the heat from compression is dissipated and the refrigerant condenses to a liquid. The liquid refrigerant is then directed to the expansion device 246 where it is reduced in pressure and vaporized, thereby reducing the temperature of the refrigerant. The cooled vapor refrigerant is then supplied to evaporator 248, where it is evaporated to provide cooling to the cabin air from blower 134. The resulting gaseous, warmed refrigerant is then returned to the compressor 240 via suction line 250 and the cycle is repeated.

As previously described, the HVAC system 104 is configured to operate in an emergency lifesaving mode during extreme temperature conditions when the HV battery system 120 has reached a predetermined minimum SOC. This predetermined minimum SOC is configured to extend the life and durability of the HV battery system 120 by not allowing the battery charge/power to go to absolute zero. While this minimum SOC will be displayed to the driver as a 0% SOC, the HV battery system 120 will still have charge/power (e.g., 20%) above the absolute zero SOC of the HV battery system 120.

In general, control system 136 includes a controller configured to control operation of the HVAC system 104 during the emergency lifesaving mode. In one example, control system 136 is configured to monitor sensors 140 to determine if one or more conditions are satisfied to activate the emergency lifesaving mode. For example, sensors 140 are configured to monitor external solar load, exterior temperature, exterior wet bulb temperature, exterior WBGT, passenger cabin temperature, passenger cabin wet bulb temperature, a passenger presence within the vehicle, or other suitable environment measuring scale. When the one or more conditions are satisfied, control system 136 is configured to operate the electric HVAC compressor 240 and the HVAC blower 134 to provide a predetermined minimum temperature (for extreme cold ambient) or a predetermined maximum temperature (for extreme hot ambient) inside the vehicle cabin. The control system 136 may then shut off all non-essential systems that draw power from the HV battery system 120.

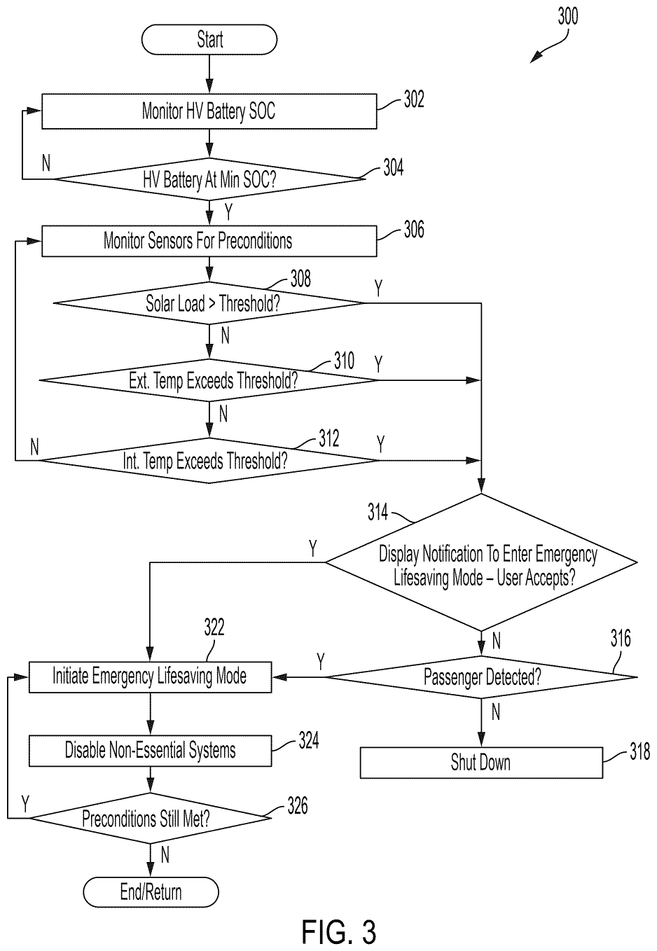

Referring now to FIG. 3, an example method 300 of operating the HVAC system 104 in the emergency lifesaving mode is illustrated according to the principles of the present application. While the method 300 specifically references the electrified vehicle 100 and its components for illustrative/descriptive purposes, it will be appreciated that the method 300 could be applicable to any suitably configured electrified vehicle.

In the example embodiment, the method begins at 302 where the control system 136 (“control”) monitors the HV battery system SOC. At 304, control determines if the HV battery system SOC has reached the predetermined minimum SOC (e.g., 20%) where measures are taken to extend the life and durability of the HV battery system 120. If an alternative power source is available (e.g., engine 128, a hydrogen fuel cell system, etc.), control also confirms the alternative power source is out of fuel. If no, control returns to 302. If yes, at 306, monitors sensors 140. In particular, control monitors the sensors 140 to determine if one or more conditions are satisfied to enter the emergency lifesaving mode. In the example embodiment, the conditions include, but are not limited to, external solar load, exterior temperature, exterior wet bulb temperature, WBGT, passenger cabin temperature, passenger cabin wet bulb temperature, and/or a passenger presence within the vehicles. In general, if the one or more conditions are not satisfied, control returns to 306. If the one or more conditions are satisfied, control proceeds to step 314. However, various example conditions are described by steps 308-312.

At 308, control determines if an external solar load is above a predetermined threshold. If yes, control proceeds to 314. If no, at 310, control determines if an exterior temperature or wet bulb temperature is above a first predetermined threshold (hot life-threatening ambient) or below a second predetermined threshold (cold life-threatening ambient). If yes, control proceeds to 314. If no, at 312, control determines if a passenger cabin temperature or wet bulb temperature is above a third predetermined threshold (hot life-threatening temperature) or below a predetermined fourth threshold (cold life-threatening temperature). If yes, control proceeds to 314. If no, control returns to 306.

At 314, if the preconditions are met, control displays a notification on the driver interface 138 (e.g., an infotainment screen) asking the passenger if they want to enter the emergency lifesaving mode due to extreme environmental/temperature conditions. If the passenger confirms, control proceeds to 322. If no confirmation is received, at 316, control determines if the sensors 140 indicate a passenger is inside the vehicle. This may be useful, for example, if an infant or otherwise incapacitated passenger is inside the vehicle. This may be determined, for example, by weight sensors on the vehicle seats or a vehicle interior camera system. If a passenger is not detected, control proceeds to 318 and shuts down the HV battery system 120 to preserve battery life. If a passenger is detected, control proceeds to 322.

At 322, control initiates the emergency life preservation mode and activates the HVAC compressor 240 and the HVAC blower 134 to provide a temperature in the vehicle cabin at a predetermined minimum or maximum temperature to sustain/preserve human life. It will be appreciated that this predetermined minimum or maximum temperature may not be a “comfortable” temperature, but rather a temperature to prevent life threatening conditions (e.g., hypothermia, hyperthermia, etc.) in order to extend the emergency lifesaving mode operation as long as possible. At 324, control disables/shuts-off all non-essential vehicle power-using functions to extend operation in the emergency lifesaving mode. For example, driving of the vehicle will be disabled. At 326, control monitors sensors 140 to determine if the extreme temperature preconditions are still met. If yes, control returns to 322 and maintains operation in the emergency life preservation mode. If no, control then ends or returns to 306.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A thermal system for an electrified vehicle having an electrified powertrain with an electric motor powered by a high voltage (HV) battery system, the thermal system comprising:
a heating, ventilation, and air conditioning (HVAC) system configured to control an environment of a cabin of the electrified vehicle, the HVAC system including a compressor, a condenser, an evaporator, and a blower;
one or more sensors; and
a controller having one or more processors and a non-transitory computer-readable storage medium having a plurality of instructions stored thereon, which, when executed by the one or more processors, cause the one or more processors to perform operations comprising:
monitor a state of charge (SOC) of the HV battery system to determine if the SOC is less than or equal to a predetermined minimum SOC;
monitor the one or more sensors to detect one or more predetermined temperature conditions dangerous to human life; and
initiate an emergency lifesaving mode when (i) the SOC is less than or equal to the predetermined minimum SOC, and (ii) the predetermined temperature conditions dangerous to human life are detected,
wherein in the emergency lifesaving mode, the HVAC system compressor and blower are activated and powered by the HV battery system to maintain the cabin environment at a temperature to prevent life threatening temperature conditions.

2. The thermal system of claim 1, wherein in the lifesaving mode, the HV battery system is allowed to be reduced to an absolute zero SOC to preserve human life.

3. The thermal system of claim 1, wherein in the lifesaving mode, all non-essential vehicle systems that utilize HV battery system power are shut down.

4. The thermal system of claim 1, wherein in the lifesaving mode, the electrified vehicle is prevented from driving.

5. The thermal system of claim 1, wherein the predetermined minimum SOC is a SOC where the HV battery system is shut down and prevents further driving to extend a life and durability of the HV battery system.

6. The thermal system of claim 1, wherein when (i) the SOC is less than or equal to the predetermined minimum SOC, and (ii) the predetermined temperature conditions dangerous to human life are detected, the controller is further configured to:
display a notification on a vehicle screen asking if a user would like to initiate the emergency lifesaving mode.

7. The thermal system of claim 6, wherein the controller is further configured to:
detect if a user does not select to initiate the emergency lifesaving mode;
determine if a passenger is detected within the vehicle cabin, if the user does not select to initiate the emergency lifesaving mode; and
automatically initiate the emergency lifesaving mode if a passenger is detected within the vehicle cabin.

8. The thermal system of claim 1, wherein the predetermined temperature conditions are an exterior wet bulb temperature.

9. The thermal system of claim 8, wherein the predetermined temperature conditions are greater than or equal to an exterior wet bulb temperature of 31 ° C.

10. The thermal system of claim 1, wherein the predetermined temperature conditions are a temperature of the vehicle cabin.

11. A method of operating a thermal system of an electrified vehicle having a passenger cabin, a high voltage (HV) battery system to power an electric motor, a heating ventilation and air conditioning (HVAC) system having a compressor and a blower, and one or more sensors, the method comprising:
monitoring, by a controller having one or more processors, a state of charge (SOC) of the HV battery system to determine if the SOC is less than or equal to a predetermined minimum SOC;
monitoring, by the controller, the one or more sensors to detect one or more predetermined temperature conditions dangerous to human life; and
initiating, by the controller, an emergency lifesaving mode when (i) the SOC is less than or equal to the predetermined minimum SOC, and (ii) the predetermined temperature conditions dangerous to human life are detected,
wherein in the emergency lifesaving mode, the HVAC system compressor and blower are activated and powered by the HV battery system to maintain an environment of the passenger cabin at a temperature to prevent life threatening temperature conditions.

12. The method of claim 11, wherein in the lifesaving mode, the HV battery system is allowed to be reduced to an absolute zero SOC to preserve human life.

13. The method of claim 11, further comprising shutting down, by the controller, all non-essential vehicle systems that utilize HV battery system power when in the lifesaving mode.

14. The method of claim 11, further comprising preventing, by the controller, driving of the electrified vehicle when in the lifesaving mode.

15. The method of claim 11, wherein the predetermined minimum SOC is a SOC where the HV battery system is shut down and prevents further driving to extend a life and durability of the HV battery system.

16. The method of claim 11, wherein when (i) the SOC is less than or equal to the predetermined minimum SOC, and (ii) the predetermined temperature conditions dangerous to human life are detected, the method further includes:
displaying, by the controller, a notification on a vehicle screen asking if a user would like to initiate the emergency lifesaving mode.

17. The method of claim 16, further comprising:
detecting, by the controller, if a user does not select to initiate the emergency lifesaving mode;
determining, by the controller and the one or more sensors, if a passenger is detected within the vehicle cabin, if the user does not select to initiate the emergency lifesaving mode; and
automatically initiating, by the controller, the emergency lifesaving mode if a passenger is detected within the vehicle cabin.

18. The method of claim 11, wherein the predetermined temperature conditions are an exterior wet bulb temperature.

19. The method of claim 18, wherein the predetermined temperature conditions are greater than or equal to an exterior wet bulb temperature of 31 ° C.

20. The method of claim 11, wherein the predetermined temperature conditions are a temperature of the vehicle cabin.
